(19) United States
(12) Patent Application Publication
(10) Pub. No.: US 2024/0308913 A1
(43) Pub. Date: Sep. 19, 2024

(54) HIGHLY WATER-RESISTANT, FLEXIBLE CEMENTITIOUS COATING

(71) Applicant: BEIJING ORIENTAL YUHONG WATERPROOF TECHNOLOGY CO. LTD., BEIJING (CN)

(72) Inventors: WILLIE LAU, Lower Gwynedd, PA (US); JOSEPH MARTIN ROKOWSKI, Barto, PA (US)

(21) Appl. No.: 18/576,030

(22) PCT Filed: Jun. 28, 2022
(86) PCT No.: PCT/US2022/035343

§ 371 Date: Jan. 2, 2024

Related U.S. Application Data
(60) Provisional application No. 63/217,511, filed on Jul. 1, 2021.

(51) Int. Cl. C04B 24/26; C04B 14/06; C04B 24/42; C04B 28/04; C04B 103/65; C04B 111/00; C04B 111/27

(52) U.S. Cl. CPC C04B 24/2688; C04B 14/06; C04B 24/42; C04B 28/04; C04B 2103/65; C04B 2111/00482; C04B 2111/27

(57) ABSTRACT

The present invention relates to a waterborne cementitious coating composition comprises: a) an aqueous polymer latex comprising: a first monomer selected from the group consisting of a vinylarene monomer and a (meth)acrylate monomer; a second monomer which is a meth(acrylate) monomer; and one or more epoxy silane; and b) an inorganic component comprising: cement; and one or more solid filler. The invention also relates to methods of forming the water-resistant, flexible cementitious coating, layer or membrane, kits for performing the methods, and coatings formed using these methods.

### CROSS-REFERENCE TO RELATED APPLICATIONS

The present application claims priority to U.S. Provisional Application No. 63/217,511, filed Jul. 1, 2021, which is incorporated by reference herein in its entirety

### FIELD OF THE INVENTION

Described herein are highly water-resistant, flexible cementitious coating compositions and methods of making same. More particularly, the highly water-resistant, flexible cementitious coating compositions are designed as protective barrier coatings which are applied, as aqueous compositions, over concrete structures. Furthermore, methods of making and using these compositions are described herein. The compositions disclosed herein can be utilized, for example, in the more demanding applications for water resistance, such as protection of underground tunnels, underground concrete pipes, below grade (for example, underground) walls and ceilings, and above grade interior bathroom wet-walls.

### BACKGROUND OF THE INVENTION

Below grade and underground concrete structures often require application of the wet coating composition in a sub-optimal ventilation environment, and, in some cases, confined spaces. Accordingly, application of solvent-borne coatings may be too hazardous to the health and safety of the workers, and regulations may require the use of waterborne compositions. Furthermore, although the cementitious coating compositions disclosed herein are suitable protective coatings for any cementitious and concrete structures (overland or underground), the coatings are specifically designed with regard to the more stringent requirements of subterranean structures, where continual contact with water is more commonly encountered. Such specialty coatings are often subject to requirements dictated by local and/or national authorities. For example, Chinese Standard GB/50108, discussed further herein, has been established to set a standard for cementitious coatings. These standards require both a minimum dry tensile strength and elongation percentage of standardized samples (standardized size dimensions and shape) of the cementitious coating, as well as a minimum percent retained tensile strength and percent retained elongation percentage as measured while the standardized samples of the cementitious coating are still damp after 7 days soaking in water. The requirements are demanding. Currently, there are no commercial waterborne cementitious coating compositions that meet, or come close to meeting, the requirements.

Cementitious coatings also present additional challenges due to the nature of the composition. Cementitious coatings must balance the brittle nature of cement with the properties of other components in the coating composition. One common issue is mudcracking, which is the formation of irregular cracks that resemble dried mud. These cracks often occur due to stresses induced by a gradient in the thickness of an applied coating. Stress differentials can cause deep cracks to form in the coating, which can compromise the performance of the coating. Mudcracking is often observed in areas where the surface is non-uniform or in corners, where material can collect (e.g., an inside corner) or can be thinned (e.g., an outside corner).

There is a need for highly water-resistant, flexible cementitious coating compositions capable of maintaining tensile strength and elongation percentage and which minimize the formation of cracks. Additionally there is a need for methods for preparing, and methods for using such compositions. This invention satisfies this unmet need in the art.

### SUMMARY OF THE INVENTION

In one aspect, the present invention relates to a waterborne cementitious coating composition comprising: a) an aqueous polymer latex comprising: a first monomer selected from the group consisting of a vinylarene monomer and a (meth)acrylate monomer; a second monomer which is a meth(acrylate) monomer; and one or more epoxy silane; and b) an inorganic component comprising: cement; and one or more solid filler. In one embodiment, the aqueous polymer latex comprises 50-90% first monomer and 10-50% second monomer by weight of dried polymer.

In one embodiment, the first monomer comprises a vinylarene monomer. In one embodiment, the first monomer comprises a (meth)acrylate monomer and wherein the first monomer is different from the second monomer. In one embodiment, first monomer comprises a vinylarene monomer selected from the group consisting of styrene, 4-methoxystyrene, 3-methoxystyrene, 2-methoxystyrene, 4-tert-butoxystyrene, 4-acetoxystyrene, 4-tert-butylstyrene, 4-vinylbiphenyl, 4-vinylbenzoic acid, 3,4-dimethoxystyrene, 2-vinylnaphthalene, 4-methylstyrene, 2-methylstyrene, 2,4-dimethylstyrene, 2,4,6-trimethylstyrene, 1,1-diphentylethylene, 4-chlorostyrene, α-methyl analogs thereof, and combinations thereof. In one embodiment, the first monomer and the second monomer independently comprise a monomer selected from the group consisting of methyl (meth)acrylate, ethyl (meth)acrylate, propyl (meth)acrylate, isopropyl (meth)acrylate, the four butyl (meth)acrylates (i.e, n-butyl, sec-butyl, iso-butyl, tert-butyl), amyl (meth)acrylate, hexyl (meth)acrylates, cyclohexyl(meth)acrylates, 2-ethylhexyl and other octyl (meth)acrylates, nonyl (meth)acrylates, decyl (meth)acrylates, lauryl (meth)acrylate, stearyl (meth)acrylate, (meth)acrylic acid, (meth)acrylamide, hydroxyethyl (meth)acrylate, glycidal (meth)acrylate, and combinations, co-polymers, and block-copolymers thereof.

In one embodiment, the aqueous polymer latex further comprises 0.1% to 10% of a third monomer selected from the group consisting of (meth)acrylic acid, itaconic acid, 3-(acryloyloxy)propionic acid, acetoacetoxy ethyl (meth)acrylate (AAEM), diacetone (meth)acrylamide (DAAM), (hydroxyethyl) (meth)acrylate (HEMA), and glycidyl (meth)acrylate (GMA).

In one embodiment, the one or more epoxy silane comprises an oligomeric epoxy silane. In one embodiment, the one or more epoxy silane comprises:

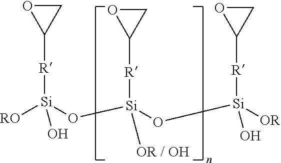

wherein R′ is —(CH₂)ₓ—O—(CH₂)_{y}—; x and y are independently from 0 to 5; R is selected from a C1 to C6 alkyl group, an aromatic group and mixtures thereof, and n is from 0 to 8, limits inclusive.

In one embodiment, the cement comprises Portland Cement or calcium aluminate cement. In one embodiment, the composition has a polymer latex to inorganic component ratio, based on solids, of from 5:1 to 1:5. In one embodiment, the filler comprises calcium carbonate, silica, fumed silica, metakaolin, or a combination thereof. In one embodiment, the composition further comprises a buffer or a superplasticizer.

In another aspect, the present invention relates to a method for forming a water-resistant, flexible cementitious coating, layer or membrane comprising the steps of applying a waterborne cementitious coating composition disclosed herein to a substrate to form a wet cementitious coating layer; and drying or curing the wet cementitious coating layer to form a dried and/or cured cementitious coating, layer or membrane. In one embodiment, the substrate comprises concrete, stone, bricks, tile, cementitious materials, metal, wood, or synthetic materials. In one embodiment, the method further comprises the step of adjusting the pH of the polymer latex to a pH of 5 to 9 before or after mixing the one or more epoxy silane with polymer latex.

In another aspect, the present invention relates to a kit comprising an aqueous polymer latex; one or more epoxy silane; cement; and one or more solid filler; wherein the aqueous polymer latex comprises a first monomer selected from the group consisting of a vinylarene monomer and a (meth)acrylate monomer; and a second monomer which is a meth(acrylate) monomer; and wherein the one or more epoxy silane comprises one or more one epoxy functional group and one or more hydrolysable siloxy, silane, or silanol functional groups. In one embodiment, the aqueous polymer latex and the one or more epoxy silane are contained in a first pack and wherein the cement and one or more solid filler are contained in a second pack.

In another aspect, the present invention relates to a water-resistant, flexible cementitious coating, layer or membrane comprising: a polymer latex comprising: a first monomer selected from the group consisting of a vinylarene monomer and a (meth)acrylate monomer; and a second monomer which is a meth(acrylate) monomer; cement; one or more solid filler; and an epoxy silane or epoxy silane residue. In one embodiment, the layer or membrane further comprises at least one additive selected from the group consisting of a buffer, and a superplasticizer.

### DETAILED DESCRIPTION OF THE INVENTION

The present invention can be understood more readily by reference to the following detailed description, examples, drawings, and claims, and their previous and following description. However, it is to be understood that this invention is not limited to the specific compositions, articles, devices, systems, and/or methods disclosed unless otherwise specified, and as such, of course, can vary. While aspects of the present invention can be described and claimed in a particular statutory class, such as the composition of matter statutory class, this is for convenience only and one of skill in the art will understand that each aspect of the present invention can be described and claimed in any statutory class.

The following description of the invention is also provided as an enabling teaching of the invention in its best, currently known aspect. To this end, those of ordinary skill in the relevant art will recognize and appreciate that changes and modifications may be made to the various aspects of the invention described herein, while still obtaining the beneficial results of the present invention. It will also be apparent that some of the benefits of the present invention may be obtained by selecting some of the features of the present invention without utilizing other features. Accordingly, those of ordinary skill in the relevant art will recognize that many modifications and adaptations to the present invention are possible and may even be desirable in certain circumstances, and are thus also a part of the present invention.

While the present invention is capable of being embodied in various forms, the description below of several embodiments is made with the understanding that the present disclosure is to be considered as an exemplification of the invention, and is not intended to limit the invention to the specific embodiments illustrated. Headings are provided for convenience only and are not to be construed to limit the invention in any manner. Embodiments illustrated under any heading or in any portion of the disclosure may be combined with embodiments illustrated under the same or any other heading or other portion of the disclosure.

Any combination of the elements described herein in all possible variations thereof is encompassed by the invention unless otherwise indicated herein or otherwise clearly contradicted by context.

Unless otherwise expressly stated, it is in no way intended that any method or aspect set forth herein be construed as requiring that its steps be performed in a specific order. Accordingly, where a method claim does not specifically state in the claims or description that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification. It is to be understood that both the foregoing general description and the following detailed description are exemplary and explanatory only and are not restrictive.

It is to be understood that the terminology used herein is for the purpose of describing particular aspects only and is not intended to be limiting. Unless defined otherwise, all technical and scientific terms used herein have the same meaning as commonly understood by one of ordinary skill in the art to which this invention belongs. In this specification and in the claims which follow, reference will be made to a number of terms which are defined herein.

As used in the specification and the appended claims, “a first pack” and “a second pack” (with respect to a two-pack composition) has no bearing on order of addition of the packs or components in the packs; it simply has the meaning of “a pack” and “another pack” and is used for ease of reference. A two-pack composition, for example, may comprise a kit in which two packs containing components of the composition are provided, such as a first pack containing polymer components (e.g., a polymer latex and one or more epoxy silane) and a second pack containing inorganic components (e.g., cement and one or more solid filler).

As used herein, the term “(meth)acrylate” in any instance encompasses the respective acrylate and methacrylate compounds.

As used herein, the term “siloxy functional group” refers to —SiX₂(OR), —SiX(OR)₂, or —Si(OR)₃, where R is an alkyl or an aromatic group, and X can be any other group, including, but not limited to, an alkyl group, a halogen, or hydrogen. The R alkyl or aromatic groups can be the same or different, even in the same siloxy functional group. Likewise, the X group can be the same or different, even in the same siloxy functional group.

As used herein, the term “silanol functional group” refers to —SiX₂(OH), —SiX(OH)₂, or —Si(OH)₃—, where X can be any group, including, but not limited to, an alkyl group, a halogen, or hydrogen. The X group can be the same or different, even in the same silanol functional group.

As used herein, the term “single functionality epoxy silane” (or the use of the term “single functionality” referring to an epoxy silane) refers to an epoxy silane molecule containing only one epoxy functional group and three groups in any combination of siloxy (Si—OR), silane (Si—R), or silanol (Si—OH) functional group.

As used herein, the term “multifunctional epoxy silane” (or the use of the term “multifunctional” referring to an epoxy silane) refers to an epoxy silane molecule containing more than one epoxy functional group and more than one siloxy- or silanol-functional group. The number of epoxy functional groups and the number of siloxy- or silanol-functional groups may or may not be the same. Unless the word “polymer” is used, it does not refer to a polymer, and does not refer to an epoxy silane polymer.

As used herein, the terms “mudcracking” or “cracking” refer to cracks that appear during the formation of a cementitious coating. These cracks can be observed by the human eye, unassisted by optics, such as a microscope.

As used herein the term, “polymer component” or “liquid polymer emulsion” or “liquid polymer latex” or “liquid component”, or “liquid” refers to the polymer latex including the water and the polymer particles dispersed therein and any other components that are dissolved or dispersed or otherwise mixed with the polymer latex.

As used herein, the terms “optional” or “optionally” mean that the subsequently described event, condition, component, or circumstance may or may not occur, and that the description includes instances where said event, condition, component, or circumstance occurs and instances where it does not.

As used herein, the phrase “sufficient to” (e.g., “conditions sufficient to”) refers to such a value or a condition that is capable of performing the function or property for which a sufficient value or condition is expressed. As will be pointed out below, the exact value or particular condition required may vary from one embodiment to another, depending on recognized variables, such as the materials employed and/or the processing conditions.

The term “by weight,” when used in conjunction with a component, unless specifically stated to the contrary, is based on the total weight of the formulation or composition in which the component is included. For example, if a particular element or component in a composition or article is said to have 8% by weight, it is understood that this percentage is in relation to a total compositional percentage of 100%. In some instances, the weight percent of a component is based on the total weight of the composition “on a dry basis,” which indicates the weight of the composition without water (e.g., less than about 1%, less than about 0.5%, less than about 0.1%, less than about 0.05%, or about 0% of water by weight, based on the total weight of the composition).

The use of numerical values in the various quantitative values specified in this application, unless expressly indicated otherwise, are stated as approximations as though the minimum and maximum values within the stated ranges were both preceded by the word “about.” In this manner, slight variations from a stated value may be used to achieve substantially the same results as the stated value. Also, the disclosure of ranges is intended as a continuous range including every value between the minimum and maximum values recited as well as any ranges that may be formed by such values. Also disclosed herein are any and all ratios (and ranges of any such ratios) that may be formed by dividing a recited numeric value into any other recited numeric value. Accordingly, the skilled person will appreciate that many such ratios, ranges, and ranges of ratios may be unambiguously derived from the numerical values presented herein and in all instances such ratios, ranges, and ranges of ratios represent various embodiments of the present invention.

The articles “a” and “an” are used herein to refer to one or to more than one (i.e. to at least one) of the grammatical object of the article. By way of example, “an element” means one element or more than one element.

As used herein, the term “about” will be understood by persons of ordinary skill in the art and will vary to some extent depending on the context in which it is used. As used herein when referring to a measurable value such as an amount, a temporal duration, and the like, the term “about” is meant to encompass variations of ±20% or ±10%, more preferably ±5%, even more preferably ±1%, and still more preferably ±0.1% from the specified value, as such variations are appropriate to perform the disclosed methods.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. Further, for lists of ranges, including lists of lower preferable values and upper preferable values, unless otherwise stated, the range is intended to include the endpoints thereof, and any combination of values therein, including any minimum and any maximum values recited.

As used herein, the term “residue” of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Furthermore, an epoxy-silane residue refers to a moiety that is the resulting product or remaining fragment of the epoxy-silane after reaction has occurred regardless of whether that moiety is a separate molecule or is now bonded to another molecule, or fragment thereof, or polymer, or fragment thereof.

As used herein, “fine particle size filler” refers to a filler having a particle size of no more than 50 microns.

As used herein, the term “substantially free of” refers to a composition having less than about 1% by weight, e.g., less than about 0.5% by weight, less than about 0.1% by weight, less than about 0.05% by weight, or less than about 0.01% by weight of the stated material, based on the total weight of the composition.

As used herein, the term “substantially,” when used in reference to a composition, refers to at least about 60% by weight, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or about 100% by weight, based on the total weight of the composition, of a specified feature or component.

The glass transition temperature, Tg for the copolymers of the invention may be measured by differential scanning calorimetry (DSC) taking the mid-point in the heat flow versus temperature transition as the Tg value.

In some embodiments, the current invention relates to a waterborne cementitious coating composition comprising: an aqueous polymer latex comprising polymerized units of: a first monomer selected from the group consisting of a vinylarene monomer and a (meth)acrylate monomer; and a second monomer which is a meth(acrylate) monomer; one or more epoxy silane; cement; and one or more solid filler. The epoxy silane may comprise one or more epoxy functional groups and one or more hydrolysable siloxy, silane, or silanol functional groups. In some embodiments, the epoxy silane may comprise two or more epoxy functional groups and two or more hydrolysable siloxy, silane, or silanol functional groups.

### Polymer Latex

In some embodiments, the waterborne cementitious coating composition comprises: an aqueous polymer latex, said latex comprising polymerized units of: a first monomer selected from the group consisting of a vinylarene monomer and a (meth)acrylate monomer; and a second monomer which is a meth(acrylate) monomer.

In one embodiment, the first monomer is a vinylarene monomer. In one embodiment, the first monomer is a (meth)acrylate monomer. In one embodiment, the first monomer is a methacrylate monomer and the second monomer is an acrylate monomer. In one embodiment, the first monomer is an acrylate monomer and the second monomer is a methacrylate monomer.

In one embodiment, the first monomer is the same compound as the second monomer. In one embodiment, the first monomer not the same compound as the second monomer. In one embodiment, In one embodiment, the aqueous polymer latex comprises a block co-polymer of first monomer and second monomer. In one embodiment, the block co-polymer may be arranged in any configuration of first monomer and second monomer.

In one embodiment, the vinylarene monomer comprises styrene. In one embodiment, the vinylarene comprises a styrene derivative. Exemplary styrene derivatives include, but are not limited to, 4-methoxystyrene, 3-methoxystyrene, 2-methoxystyrene, 4-tert-butoxystyrene, 4-acetoxystyrene, 4-tert-butylstyrene, 4-vinylbiphenyl, 4-vinylbenzoic acid, 3,4-dimethoxystyrene, 2-vinylnaphthalene, 4-methylstyrene, 2-methylstyrene, 2,4-dimethylstyrene, 2,4,6-trimethylstyrene, 1,1-diphentylethylene, 4-chlorostyrene, a-methyl analogs thereof, and combinations thereof.

In one embodiment, the (meth)acrylate monomer comprises any meth(acrylate) known in the art. A person having ordinary skill in the art would appreciate that the term “(meth)acrylate” in any instance encompasses the respective acrylate and methacrylate compounds. In one embodiment, the meth(acrylate) monomer comprises an alkyl (meth)acrylate. In one embodiment, the alkyl (meth)acrylate monomer comprises an alkyl group having 1 to 18 carbon atoms. Exemplary (meth)acrylate monomers include, but are not limited to, methyl (meth)acrylate, ethyl (meth)acrylate, propyl (meth)acrylate, isopropyl (meth)acrylate, the four butyl (meth)acrylates (i.e, n-butyl, sec-butyl, iso-butyl, tert-butyl), amyl (meth)acrylate, hexyl (meth)acrylates, cyclohexyl(meth)acrylates, 2-ethylhexyl and other octyl (meth)acrylates, nonyl (meth)acrylates, decyl (meth)acrylates, lauryl (meth)acrylate, stearyl (meth)acrylate, (meth)acrylic acid, (meth)acrylamide, hydroxyethyl (meth)acrylate, glycidal (meth)acrylate, meth(acrylic) acid, itaconic acid, and combinations, co-polymers, and block-copolymers thereof. In one embodiment, the (meth)acrylate monomer is selected from the group consisting of n-butyl (meth)acrylate, methyl (meth)acrylate, 2-ethyl-hexyl (meth)acrylate, (meth)acrylic acid, and itaconic acid.

There is no particular limit to the relative composition of first monomer and second monomer components in the polymer latex. In one embodiment, the combination of first monomer and second monomer make up at least 50% of the polymer latex by weight of dried polymer. In one embodiment, polymer latex comprises between 1% and 99% first monomer by weight. In one embodiment, the polymer latex comprises about 10%-90% first monomer. In one embodiment, the polymer latex comprises about 10%-50% first monomer. In one embodiment, the polymer latex comprises about 15%-40% first monomer. In one embodiment, the polymer comprises about 20%-35% first monomer. In one embodiment, the polymer comprises about 5.0%, 10.0%, 15.0%, 20.0%, 25.0%, 30.0%, 35.0%, 40.0%, 45.0%, 50.0%, 55.0%, 60.0%, 65.0%, 70.0%, 75.0%, 80.0%, 85.0%, 90.0%, or 95.0% first monomer by weight. Each of the foregoing numbers can be preceded by the word “about,” “at least about,” or “less than about,” and any of the foregoing numbers can be used singly to describe an open-ended range or in combination to describe a closed-ended range.

In one embodiment, polymer latex comprises between 1% and 99% second monomer by weight. In one embodiment, the polymer latex comprises about 10%-90% second monomer. In one embodiment, the polymer latex comprises about 20%-95% second monomer. In one embodiment, the polymer latex comprises about 50%-90% second monomer. In one embodiment, the polymer comprises about 60%-80% second monomer. In one embodiment, the polymer comprises about 5.0%, 10.0%, 15.0%, 20.0%, 25.0%, 30.0%, 35.0%, 40.0%, 45.0%, 50.0%, 55.0%, 60.0%, 65.0%, 70.0%, 75.0%, 80.0%, 85.0%, 90.0%, or 95.0% second monomer by weight. Each of the foregoing numbers can be preceded by the word “about,” “at least about,” or “less than about,” and any of the foregoing numbers can be used singly to describe an open-ended range or in combination to describe a closed-ended range.

In one embodiment, the composition further comprises a third monomer. In one embodiment, the third monomer is a different compound from both the first monomer and the second monomer. In one embodiment, the third monomer comprises any monomer disclosed herein. In one embodiment, the third monomer comprises any mixture of monomers. In one embodiment, the third monomer does not make up more than 40%, more than 30%, more than 20%, or more than 10% by weight of the total polymer matrix. In one embodiment, the third monomer aids in stabilization of the copolymer in water, or for any other reason. In one embodiment, the third monomer may help confer stability in water. In one embodiment, the third monomer is (meth)acrylic acid, itaconic acid, 3-(acryloyloxy)propionic acid, or any other carboxylic acid containing monomers, all of which may be present in the latex (and/or in the cementitious coating composition) in an anionic form (for example, as carboxylates) or in a predominantly or partially anionic form. In one embodiment, the third monomer is a functional monomer included to instill desired properties in the polymer latex. In one embodiment, the third monomer comprises acetoacetoxy ethyl (meth)acrylate (AAEM), diacetone (meth)acrylamide (DAAM), (hydroxyethyl) (meth)acrylate (HEMA), or glycidyl (meth)acrylate (GMA). In one embodiment, the third monomer is present in the polymer matrix in an amount of from 0.1% to 10.0% by weight, for example, from 0.2% to 5%, from 0.5% to 3.0%, or from 1% to 2.5%. In one embodiment, the percentage described herein is based on the weight of stabilizing monomer as a % of total dried weight of the polymer latex including the stabilizing monomer).

In one embodiment, the polymer latex further comprises anionic monomers such as sulfate, sulfonate, phosphate, phosphonate, phenolate monomers, and the like, or monomers that can be converted to these anionic forms. In one embodiment, the polymer latex comprises monomers comprising non-ionic groups which exhibit stearic effects and which contain long ethoxylate or hydrocarbon tails, or polymerizable surfactants, as known in the art, may also be present in the polymer latex. Monomers that are present in the polymer latex primarily to help confer stability in water are preferably used in an amount of from 0.1% to 10.0%, for example, from 0.2% to 5% or from 0.5% to 3.0% (percentage based on the weight of stabilizing monomer as a % of total dried weight of the polymer latex including the stabilizing monomer). Carboxylate, sulfate, sulfonate, phosphate, phosphonate, phenolate monomers, and the like, or monomers that can be converted to these anionic forms, as well as polymerizable surfactants, may be suitable as additional monomers that may help confer stability of the copolymer in water. In one embodiment, the anionic monomers may additionally include a counter ion, such as, for example, an ammonium ion (NH₄⁺). Latexes formed including such monomers may have a pH of, for example, 9 to 10, although, for the purposes of the current invention, the actual pH of the latex is not particularly limited. Any other additional monomer, in its polymerized form, may be present in the copolymer, many of which are commonly found in copolymers, such as, for example without limitation, acrylonitrile and/or acrylamide.

In some embodiments, the Tg of the copolymer is from −60° C. to +60° C. In some embodiments, the Tg of the copolymer is at least −50° C., at least −40° C., or at least −30° C. In some embodiments, the Tg of the copolymer is no greater than +50° C., no greater than +40° C., or no greater than +30° C. For example, the Tg of the copolymer (C) can be −60, −50, −40, −30, −28, −26, −24, −22, −20, −18, −16, −14, −12, −10, −8, −6, −4, −2, 0, +2, +4, +6, +8, +10, +12, +14, 16, +18, +20, +22, +24, +26, +28, +30, +40, +50, +60. Each of the foregoing numbers can be preceded by the word “about,” “at least about,” or “less than about,” and any of the foregoing numbers can be used singly to describe an open-ended range or in combination to describe a closed-ended range. For example, and without limitation, the Tg of the copolymer can be at least about −25° C., at least about 0° C., about −20° C. to about 0° C., less than about +10° C., less than about 0° C., or less than about −10° C.

The polymer latex is usually provided to the formulation mixture as an aqueous colloidal suspension or emulsion of the copolymer comprising the first monomer and the second monomer. Such latex dispersions are formed using methods known to those of skill in the art and generally comprise water in an amount of from about 10% to about 90% by weight of the latex. In one embodiment, the latex dispersion comprises water in the amount of from about 70% to 80% by weight of the latex. In one embodiment, the latex dispersion comprises water in the amount of about 70% by weight of the latex. In one embodiment, the latex dispersion comprises water in the amount of about 80% by weight of the latex. In one embodiment, the emulsion may further comprise include small quantities of one or more of an emulsifier such as Disponil® FES 32, a surfactant, initiator or initiator residue fragments, polymerization catalysts, chain transfer agents (such as but not limited to thiols such as n-dodecyl mercaptan (nDDM) or tetradecyl mercaptan, esters of 2-mercaptoacetic acid such as 2-ethylhexyl 2-mercaptoacetate, esters of 3-mercaptopropionic acid such as dodecyl 3-mercaptopropionate, and halocarbons such as carbon tetrachloride), and the like.

The polymer latex may be prepared by any technique known in the art, such as emulsion polymerization, interfacial polymerization, or suspension polymerization. Emulsion polymerization techniques for preparing aqueous dispersions of latex polymer particles from ethylenically unsaturated monomers are well known in the art, and any conventional emulsion polymerization technique may be used, such as single and multiple shot batch processes, and continuous processes. If desired, a monomer mixture can be prepared and added gradually to the polymerization vessel. The monomer composition may be varied during the course of the polymerization, such as by varying the composition of the monomer being fed into the vessel. Both single and multiple stage polymerization techniques may be used.

The polymer latex particles can be prepared using a seed polymer emulsion to control the number of particles produced by the emulsion polymerization as is known in the art. In one embodiment, the particle size of the polymer latex particles is between about 100 nm and about 500 nm. In one embodiment, the particle size is between about 200 and about 400 nm. In one embodiment, the particle size is between about 250 nm and about 400 nm. In one embodiment, the particle size is about 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, or 400 nm. In one embodiment, the particles are bi-or poly-modal and comprise particles having multiple discrete size ranges.

In one embodiment, the particle size of the polymer latex particles can be controlled by adjusting the initial surfactant charge as is known in the art. Aggregation of polymer particles is discouraged by including one or more micelle-forming, stabilizing surfactant in the polymerization mix, which surfactants may be anionic, non-ionic, or a mixture thereof, as known in the art. The preparation of polymer latexes is discussed generally in D. C. Blackley, Emulsion Polymerization (Wiley, N.Y., 1975).

In one embodiment, the composition comprises a surfactant such as Triton X-100, Triton X-102, Triton X-112, Tergitol 15-S-7, Tergitol 15-S-9, Tergitol 15-S-12, Tergitol TMN-6, or Tergitol TMN-10. In one embodiment, the composition comprises 1%-10% surfactant. In one embodiment, the composition comprises about 1%, about 2%, about 3%, about 4%, about 5%, about 6%, about 7%, about 8%, about 9%, or about 10% surfactant.

### Epoxy Silane

In certain embodiments, the cementitious coating composition of the present invention includes one or more epoxy silane. The epoxy silane may comprise one or more epoxy functional groups and one or more hydrolysable siloxy, silane, or silanol functional groups. In some embodiments, the epoxy silane comprises one or more epoxy functional groups and one or more hydrolysable siloxy, silane, or silanol functional groups. In some embodiments, the epoxy silane of the invention comprises at least three epoxy functional groups and at least three hydrolysable siloxy, silane, or silanol functional groups. In some embodiments, the epoxy silane comprises an oligomeric epoxy silane.

According to some embodiments, the one or more epoxy silane comprises:

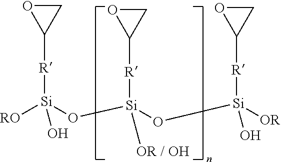

wherein R′ is —(CH₂)ₓ—O—(CH₂)_{y}—, wherein x and y are independently from 0 to 5; R is selected from a C1 to C6 alkyl group or an aromatic group, and may be further selected from the group consisting of —CH₃, —CH₂—CH₃, —CH₂—CH₂—CH₃, —CH(CH₃)₂, —CH₂—CH₂—CH₂—CH₃, —C(CH₃)₃ and mixtures thereof; and n is from 0 to 8, such as, for example, from 2 to 6 or from 3 to 5.

The cementitious coating composition can comprise one or more epoxy silane, comprising one or more epoxy functional groups and one or more hydrolysable siloxy, silane, or silanol functional groups, in an amount (% by weight, based on the total weight of the wet cementitious coating composition after mixing of the polymer component and the inorganic component before drying) of 0.01, 0.02, 0.05, 0.1, 0.2, 0.25, 0.3, 0.4, 0.5, 0.6, 0.7, 0.8, 0.9, 1.0, 1.2, 1.4, 1.6, 1.8, 2.0, 2.5, 3.0 or 5.0. Each of the foregoing numbers can be preceded by the word “about,” “at least about,” or “less than about,” and any of the foregoing numbers can be used singly to describe an open-ended range or in combination to describe a closed-ended range. For example, and without limitation, the amount of epoxy silane (% by weight, based on the total weight of the wet cementitious coating composition can be at least about 0.01% by weight, or at least about 0.02% by weight, or at least about 0.05% by weight, or at least about 0.1% by weight, or at least about 0.25% by weight, or about 0.2% by weight to about 2.0% by weight, or about 0.25% by weight to about 1.5% by weight, or less than about 2.5% by weight, based on the total weight of the wet cementitious coating composition after mixing of the polymer component and the inorganic component before drying.

### Cement

The cementitious coating composition comprises both polymer and cement, and these coatings are therefore “polymer-modified concretes” (as opposed to “polymer concretes”, in which the polymer replaces the cement). Furthermore, the cement is preferably a hydraulic cement, since non-hydraulic cements cannot be hardened (cured) when exposed to water. The most commonly used hydraulic cement is Portland cement, and these hydraulic cements have the ability to set and harden under water. Like Portland cement concrete, the primary curing mechanism for polymer-modified concrete is hydration of the cement binder. In certain embodiments, the cement in the cementitious coating composition is or comprises Portland cement.

Suitable hydraulic cements in the inventive compositions include all such chemical combinations of lime, silica, and alumina, or of lime and magnesia, silica, and alumina and iron oxide (for example, magnesia may replace part of the lime; and iron oxide may replace part of the alumina), as are commonly known as hydraulic natural cements. Hydraulic natural cements include grappier cements, pozzolan cements, natural cements, Portland cements, white cements and aluminous cements. Pozzolan cements include slag cements made from slaked lime and granulated blast furnace slag. In some embodiments, the cement is or comprises a calcium aluminate cement, also known as high alumina cement. In some embodiments, Portland cement is preferred for its superior strength among the natural cements. In addition to ordinary construction grades of Portland cement or other hydraulic natural cements, modified natural cements and Portland cements, such as high-early strength cement, heat-resistant cement, and slow-setting cement can be used in the present invention. Among Portland cements, any of the ASTM types I, II, III, IV, or V can be used. The term, “gray cement” as used herein refers to ordinary Portland cement. The term, “white cement” refers to white Portland cement. Portland cement can be any of the types defined in ASTM C 150, which details the types of Portland cements. Alternatively or in addition, the cements as described in ASTM C 1157 may also be used.

### Polymer:Cement Ratios

In certain embodiments, the weight ratio, based on solids, of polymer (e.g., aqueous polymer latex and one or more epoxy silane) to cement in the wet or dry composition is 1:10, 1:8, 1:6, 1:5, 1:4, 1:3, 1:2, 1: 1, 2:1, 3:1, 4:1, 5:1, 6:1, 8:1, 10: 1. Each of the foregoing numbers can be preceded by the word “about,” “at least about,” or “less than about,” and any of the foregoing numbers can be used singly to describe an open-ended range or in combination to describe a close-ended range. For example, the cementitious coating composition can have a polymer to cement weight ratio, based on solids, of at least about 1:1, or from about 5:1 to about 1:5, or about 1:1 to about 1:5, or about 1:1 to about 1:4, or about 1:2 to about 1:4.

The organic components in the composition may retard the cure of the hydraulic cement, but this effect may be offset by the addition of hydraulic cement cure accelerators, as are known in the art, such as sodium carbonate or sodium hydroxide. Suitable amounts of sodium ion-containing accelerator may be, for example, from 0.25 to 5.0 weight percent on cement solids, or 0.5 to 2.0 weight percent on cement solids. The order of addition is not particularly limited; for example, for a 2-pack system the cement cure accelerator(s) may be included in either or both packs.

### Fillers

In some embodiments, the cementitious coating composition comprises one or more filler, which may take the form of an aggregate material or a fine particle size filler. The aggregate material may include sand, although any particulate material (crushed/fragmented or otherwise) may be used including stone, gravel, pebbles, granite, marble chips, mica, ground glass, ground slag, diatomaceous earth, trap rock, fly ash, emery powder, and the like, as well as coarser grades of calcium carbonate, silica, Wollastonite (calcium silicate, CaSiO₃), natural or synthetic fibers, and talc. In general, the nature of the aggregate (for example, choice of material(s), average particle sizes, and shapes, etc.) is dependent on the intended use of the cured cementitious composition, and mixtures of such fillers (weight average particle size of greater than 50 microns) can be used to fine-tune properties (e.g. rheological properties) and costs. In addition to the coarser aggregate material, the cementitious coating composition may comprise one or more fine particle size filler (weight average particle size of no more than 50 microns). Such fine particle size fillers are not particularly limited in type, and may include, for example, fine grades of silica and fumed silica, Wollastonite, calcium carbonate, barium sulfate, metakaolin, natural or synthetic fibers, etc. The fine particle size filler contributes to the compressive strength of the cured coating composition, with compressive strength and particle size inversely related in general. However, if too fine a particle size filler is employed, the resulting coating composition can become too thick and sticky for easy application.

In certain embodiments, the filler in the cementitious coating composition is or comprises calcium carbonate, silica, fumed silica, metakaolin, or a combination thereof.

In some embodiments, the filler may be present in the cementitious coating composition in an amount ranging from about 0% to about 80% by weight based on the total weight of the inorganic component. For example, the filler may be present in an amount of at least 10%, at least 20%, at least 30%, at least 40%, or 50% by weight based on the total weight of the inorganic component. The filler may be present in an amount of less than 90%, less than 80%, less than 70%, less than 60%, less than 50%, or less than 40% by weight based on the total weight of the inorganic component.

In certain embodiments the ratio of the polymer component to the inorganic component can range from 1:0.5 to 1:1 to 1:2, such as 1:0.6, 1:0.8, 1:1.1, 1:1.2, 1:1.3, 1:1.4, 1:1.5, 1:1.6, 1:1.7, 1:1.8, 1:1.9. It is to be understood that the polymer component comprises the aqueous polymer latex and any additives therein and that the inorganic component comprises the cement and fillers and any additives therein.

### Superplasticizer

The cementitious coating composition may comprise one or more superplasticizer. A superplasticizer, sometimes referred to as a water reducer, improves dispersion of the coating composition, so that less water is needed for good rheological properties, i.e. the ability to spread the coating in a thin, even layer prior to curing. In some embodiments, the cementitious coating composition comprises one or more superplasticizer selected from poly(melamine sulfonate), poly(naphthalene sulfonate), polycarboxylate, salts thereof and derivatives thereof, and combinations of the foregoing. Examples include poly(EO)-grafted polyacid species, oligo(EO)-grafted polyacid species (where EO refers to a polymerized unit or residue of ethylene oxide), sodium salts of poly(melamine sulfonate), poly(naphthalene sulfonate), and polycarboxylates and sodium naphthalene sulfonate formaldehyde.

The cementitious coating composition can comprise one or more superplasticizer in an amount (% by weight, based on the total weight of the wet cementitious coating composition) of 0.1, 0.2, 0.25, 0.3, 0.4, 0.5, 0.6, 0.7, 0.8, 0.9, 1.0, 1.2, 1.4, 1.6, 1.8, 2.0, 2.5 or 3.0. Each of the foregoing numbers can be preceded by the word “about,” “at least about,” or “less than about,” and any of the foregoing numbers can be used singly to describe an open-ended range or in combination to describe a closed-ended range. For example, and without limitation, the amount of superplasticizer (% by weight, based on the total weight of the wet cementitious coating composition can be at least about 0.1% by weight, or at least about 0.25% by weight, or about 0.2% by weight to about 1.0% by weight, or about 0.25% by weight to about 0.5% by weight, or less than about 2.5% by weight, based on the total weight of the wet cementitious coating composition. Non-limiting examples of the superplasticizer that can be included in the composition include Sodium Naphthalene Sulfonate Formaldehyde UNF-5 from Muhu Construction chemicals (China), sulphonated melamine formaldehyde (SMF), sulphonated naphthalene formaldehyde (SNF), modified lignosulphonates (MLS) and polycarboxylate derivatives.

### Dispersing Agent

In some embodiments, the composition described herein further comprises a dispersing agent. The dispersing agent may be used in addition to the superplasticizer. As used herein, the dispersing agent refers to any substance that when added to the sample suspension improves the separation of particles and assists in prevention of agglomeration or settling. The dispersing agent can include a non-surface active substance or a surface-active substance. Addition of dispersing agents may affect chemical and physical properties of the sample, for example, dispersing agents may deflocculate solids or reduce the viscosity of a final dispersion or paste. In some embodiments, addition of a dispersing agent may allow formation of final dispersions having higher amounts of dispersed powdered material. As one of ordinary skill in the art would readily appreciate, the dispersing additive may be useful to produce stable formulations and ensure longer shelf life and storage. Suitable dispersing agents include various cellulosics, such as hydroxyl propyl cellulose, methyl cellulose, carboxymethylcellulose, sodium carboxymethylcellulose, paraben derivatives, polyacid polymers such as poly(acrylic acid) or poly(methacrylic acid) or copolymers comprising polymerized units of acrylic acid or methacrylic acid, nonionic surfactants, or any combination thereof. Some commercial products marketed as wetting agents/aids may also function as dispersants. Dispersing agents typically can be used in an amount of about 0.1% to about 5.0%, preferably about 2.0% to about 4.0%, by weight of the total (wet) cementitious coating composition.

### Buffer

In some embodiments, the cementitious coating composition may further comprise one or more buffer, or residue thereof. Any suitable buffer may be employed to adjust the pH of the cementitious coating composition (or component thereof), as described below. In some embodiments, potassium monobasic phosphate or diammonium phosphate may be employed to adjust the pH of the cementitious coating composition. Accordingly, in some embodiments, the cementitious coating composition may further comprise potassium monobasic phosphate, or residue thereof, added in an amount suitable to adjust the pH of the cementitious coating composition (or component thereof) to a desired target pH, as discussed below.

### Other Additives

If desired, other additives as known in the art can be included in the wet mix, such as thickeners, rheology control agents, UV stabilizers, colorants, biocides, cosolvents, wetting agents, defoamers, additional water, etc.

In some embodiments, the cementitious coating composition further comprises a defoamer. The defoamer may be selected from, for example, silicone defoamers and other defoamers such as are known or used in the art. The defoamer may optionally be provided on a carrier such as fumed silica so that it can be mixed into the powdered cement.

In certain embodiments, and as readily understood by one of ordinary skill in the art, the methods described herein may be performed in any suitable container known in the art that is capable of withstanding the method's conditions. Any suitable mixing apparatus may be used, and the manner in which the components are mixed is not particularly limited, for example the components may be mixed at room temperature and pressure. The duration of addition of the various components, and the duration of mixing at any stage during the process of formulating the wet composition, is not particularly limited, although, typically, the epoxy silane coupling agent may be metered in gradually over several minutes or more with stirring. The order of addition is also not particularly limited. Any suitable stirrer may be used, including, for example, ribbon blenders or rotary blenders such as an overhead pitched propeller blade attached to a mechanical disperser or stirrer.

In certain embodiments, the invention described herein relates to methods for providing a cementitious coating, layer or membrane.

Disclosed are methods for forming a cementitious coating, layer or membrane comprising, consisting of or consisting essentially of: applying a waterborne cementitious coating composition comprising a polymer latex, one or more epoxy silane, cement, and one or more solid filler to a substrate to form a wet cementitious coating layer; and allowing or facilitating the wet cementitious coating layer to dry and/or cure to form a dried and/or cured cementitious coating, layer or membrane.

The substrate may be selected from, for example, concrete, stone, bricks, tile, cementitious materials, metal, wood, fiberglass, and synthetic materials.

In some embodiments, the cementitious coating, layer or membrane can be applied for preservation of historic structures or items, such as buildings, architectural elements, statues, etc. The cementitious coating, layer or membrane may also be applied as a waterproofing coating, layer or membrane, such as, for example, a roofing material, pond liner, pool liner, water storage tank liner, dams, etc.

Another aspect of the present invention relates to a kit. In some embodiments, the kit may comprise an aqueous polymer latex, one or more epoxy silane, cement, and one or more solid filler. The epoxy silane may comprise one or more epoxy functional group and one or more hydrolysable siloxy, silane, or silanol functional group.

The kit may be provided such that the components are contained in individual packs, or certain components may be grouped together in a pack.

In some embodiments, the kit is provided as a 2-pack kit. For example, the 2-pack kit may include a first pack which may comprise the aqueous polymer latex, optionally with other components, such as the other wet (liquid) components (this is sometimes referred to as the wet pack or wet mix, or the liquid or the liquid component, even though it is understand that the latex comprises a waterborne dispersion of polymer particles.). A second pack may comprise the cement and one or more solid filler(s), optionally with other components, such as the other dry (solid) components (this is sometimes referred to as the dry pack or dry mix or the powder or the powder component or the inorganic component). However, it should be noted that it is not essential that only dry components are present in the dry pack, or that only wet components are present in the wet pack. The 2-pack kit is sometimes preferred because it allows a longer shelf life and the two packs can be pre-prepared, and (optionally) packaged and stored off-site before mixing at the site of application of the wet composition. In some embodiments, a two-pack kit, for example, may have a shelf life of 6 months or more, such as, for example, at least 12 months, at least 18 months, or at least 24 months. A 1-pack system is more appropriate in cases where all components can be mixed together at the site of application of the wet composition, and the substrate coated soon thereafter, preferably within 24 hours of mixing or sooner.

In other embodiments, the kit may be provided with more than two packs. For example, a third pack may comprise additives specific to the needs of a particular application.

Another aspect of the present invention relates to methods for preparing a cementitious coating composition. In some embodiments, a method for preparing a cementitious coating composition comprises mixing an aqueous polymer latex, one or more epoxy silane, cement, and one or more solid filler. In certain embodiments, the cementitious coating composition is prepared from a kit containing one or more packs comprising the components.

In some embodiments, regardless of whether the method involves a 1-pack or a 2-pack composition or a kit, the method further comprises the step of adjusting the pH of the polymer latex to a pH of 5 to 9 before or after combining the epoxy silane with the polymer latex. In some embodiments, the pH of the polymer latex is adjusted to a pH of 6 to 8 before or after combining the epoxy silane with the polymer latex. In some embodiments, the step of adjusting the pH of the polymer latex, either to a pH of 5 to 9 or pH of 6 to 8, occurs prior to combining the epoxy silane with the polymer latex.

In certain embodiments, either before or after combining the epoxy silane with the polymer latex, the pH of the polymer latex is adjusted to a pH of 5, 5.2, 5.4, 5.6, 5.8, 6, 6.2, 6.4, 6.6, 6.8, 7, 7.2, 7.4, 7.6, 7.8, 8, 8.2, 8.4, 8.6, 8.8, or 9. Each of the foregoing numbers can be preceded by the word “about,” “at least about,” or “less than about,” and any of the foregoing numbers can be used singly to describe an open-ended range or in combination to describe a close-ended range. For example, in some embodiments, the pH can be at least about 5.2, about 6.0 to about 8.0, or about 6.4 to about 7.6, or less than about 7.0. Test methods as are known in the art may be used for pH determinations.

In certain embodiments, the step of adjusting the pH of the polymer latex is performed by addition of a buffer such as potassium monobasic phosphate or diammonium phosphate.

The pH of the mixture generally rises upon addition of cement, typically to a pH of 10-12, although the actual pH at this stage is not particularly limited. Optionally, the pH of the final composition may be adjusted down toward (or even lower than) pH of 7, but, alternatively, the composition can also be used without adjusting the pH. The value of the final pH is not particularly limited.

Also disclosed herein is a water-resistant cementitious coating, layer or membrane produced by any of the methods disclosed herein. For example, also disclosed herein is a water-resistant, flexible cementitious coating, layer or membrane comprising: a polymer latex described herein; cement; one or more solid filler; and one or more epoxy silane or epoxy silane residue; wherein the epoxy silane or epoxy silane residue comprises one or more epoxy functional groups, one or more of which may be present as a reacted epoxy functional group, and one or more hydrolysable siloxy, silane, or silanol functional groups, one or more of which may be present as a reacted siloxy, silane, or silanol functional group.

In certain embodiments, the epoxy silane or epoxy silane residue comprises two or more epoxy functional groups, one or more of which may be present as a reacted epoxy functional group, and two or more hydrolysable siloxy, silane, or silanol-functional groups, one or more of which may be present as a reacted siloxy, silane, or silanol functional group. In other embodiments, the epoxy silane or epoxy silane residue comprises at least three epoxy functional groups, one or more of which may be present as a reacted epoxy functional group, and at least three hydrolysable siloxy, silane, or silanol functional groups, one or more of which may be present as a reacted siloxy, silane, or silanol functional group.

In certain embodiments, the water-resistant, flexible cementitious coating, layer or membrane further comprises one or more buffer, or residue thereof. In one embodiment, the buffer, or residue thereof, comprises potassium monobasic phosphate, or residue thereof. In one embodiment, the buffer comprises diammonium phosphate.

In certain embodiments, the water-resistant, flexible cementitious coating, layer or membrane further comprises a superplasticizer. In certain embodiments, the superplasticizer is selected from poly(melamine sulfonate), poly(naphthalene sulfonate), polycarboxylate, salts thereof and derivatives thereof, and combinations of the foregoing.

In certain embodiments, the water-resistant, flexible cementitious coating, layer or membrane is capable of retaining tensile strength and/or elongation properties after exposure to water. Using the test methods described below on test specimens that have been conditioned for at least 24 hours at 23+/−2° C. and 50% relative humidity, the cementitious coating, layer or membrane may have a water resistance tensile retention rate of at least 40%, at least 45%, at least 50%, at least 60%, at least 70%, at least 80%, at least 90%, at least 100%, or greater than 100% after subjecting the test specimens to 7 days soaking in water.

In some embodiments, the water-resistant, flexible cementitious coating, layer or membrane may have a water resistance elongation retention rate of at least 40%, at least 45%, at least 50%, at least 60%, at least 70%, at least 80%, at least 90%, at least 100%, or greater than 100% after subjecting the test specimens to 7 days soaking in water.

In some embodiments, the water-resistant, flexible cementitious coating, layer or membrane may have a water resistance tensile retention rate and a water resistance elongation retention rate of at least 40%, at least 45%, at least 50%, at least 60%, at least 70%, at least 80%, at least 90%, at least 100%, or greater than 100% after subjecting the test specimens to 7 days soaking in water.

In certain embodiments the water-resistant, flexible cementitious coating, layer or membrane may resist mudcracking when the cementitious coating, layer or membrane is formed. After drying, the cementitious coating, layer or membrane may not exhibit cracks visible to the human eye, unassisted by optics, such as a microscope. In some embodiments, a dried cementitious coating, layer or membrane does not exhibit cracks greater than 2 mm at the narrowest dimension, e.g., the width of the crack does not exceed 2 mm. In some embodiments, the dried cementitious coating, layer or membrane does not exhibit cracks greater than 1 mm, greater than 0.5 mm, greater than 0.25 mm, or greater than 0.1 mm. As used herein, the term “dried cementitious coating, layer or membrane” refers to a cementitious coating, layer or membrane that has dried for at least 24 hours at a temperature of 23° C.±2° C. and 50% relative humidity.

In some embodiments, the water-resistant, flexible cementitious coating, layer or membrane may have a water retention tensile retention rate and/or water resistance elongation retention rate of at least 40%, at least 45%, at least 50%, at least 60%, at least 70%, at least 80%, at least 90%, at least 100%, or greater than 100% after subjecting the test specimens to 7 days soaking in water, and the dried cementitious coating, layer or membrane does not exhibit cracks greater than 2 mm, greater than 1 mm, greater than 0.5 mm, greater than 0.25 mm, or greater than 0.1 mm.

The compositions and resulting coatings, layers or membranes of the invention may be used in multiple fields and applications, for example, and without limitation, as a coating or sealant on such substrates as concrete, stone, bricks, tile, cementitious substrates, metal, wood, fiberglass, and synthetic materials, and especially applied to inner, outer or concealed areas of civil engineering construction, building materials, and many more. The compositions of the invention may be used as a bond coat or adhesive in adhering new cement concrete to existing concrete, such as a new concrete overlay for an existing concrete floor, as a grout to repair cracks in existing concrete structures; as a bonding agent to adhere fresh cement concrete to steel reinforcing rods or plates, as, for example, in pre-tensioned or post-tensioned structural elements; as an adhesive grout for bonding aggregates, panels, tiles or the like to walls to provide a decorative effect; as a liner for ponds, swimming pools, fountains, and water tanks; as a protective overlay for concrete structures such as dams, bridge decks, piers, utility pylons, buildings and sculptures, and the like subject to exterior exposure, as well as indoor concrete surfaces such as flooring. Certainly, the compositions could also be utilized as the concrete structure itself (as opposed to just the protective coating layer over a concrete structure or other substrate), however, the added cost of such a structure may, in some cases, be prohibitive.

Although the cementitious coating compositions disclosed herein are suitable protective coatings for any cementitious and concrete structures (overland or underground), the product is particularly advantageously used in applications requiring a high degree of water resistance or waterproofing, such as subterranean structures, where continual contact with water is more commonly encountered. The compositions disclosed herein can be utilized, for example, in the more demanding applications for water resistance, such as protection of underground tunnels, underground concrete pipes and below grade (for example, underground) walls and ceilings.

In general, the coating compositions can be applied over a wide range of thicknesses, depending on the requirements of the application.

Some embodiments disclosed herein are set forth in the following clauses, and any combination of these clauses (or portions thereof) may be made to define an embodiment.

The present invention is further defined in the following Examples, in which all parts and percentages are by weight, unless otherwise stated. It should be understood that these examples, while indicating preferred embodiments of the invention, are given by way of illustration only and are not to be construed as limiting in any manner. From the above discussion and these examples, one skilled in the art can ascertain the essential characteristics of this invention, and without departing from the spirit and scope thereof, can make various changes and modifications of the invention to adapt it to various usages and conditions.

### EXPERIMENTAL EXAMPLES

Cementitious two pack coatings for waterproofing are known in the industry and generally the most successful ones for waterproofing characteristics (i.e. good tensile strength and especially good tensile strength while wet) are based on different polymer technologies. Styrene-butadiene resins (SBR) used in these applications are very hydrophobic and have good water resistance properties but are not UV durable simply due to the poor UV resistance of the SBR polymer.

This invention combines the benefits of 1) acrylic composition for use in exterior applications; 2) soft, low Tg polymers for flexibility; 3) hydrophobic monomers and styrene and methacrylic acid for general water resistance; and 4) oligomeric epoxy silane for crosslinking to impart improved wet tensile strength and additional water resistance properties.

The determination of Elongation and Tensile Strength values for the various cementitious coating compositions described in the Examples section follows the method of ASTM D-2370-98 (Reapproved 2002) (“Standard Test Method for Tensile Properties of Organic Coatings”, directed at free films of an organic coating), with the test specimen shape Die C described in ASTM D412-15A (“Standard Test Method for Vulcanized Rubber and Thermoplastic Elastomers”, directed at vulcanized rubber and thermoplastic elastomers in the form of standard dumbbell-shaped specimens). The reported data feature the initial tensile strength (MPa)—the maximum load per original unit area at which a specimen fails or yields in a tension (pull) test; and the initial elongation (%)—the increase in specimen length from the point of initial load application to the point of film rupture in a tension test. The initial testing is performed on test specimens that have been conditioned for at least 24 hours at 23+/−2° C. and 50% relative humidity and then tested in the same environment. In addition, each type of test is performed again on test specimens that have been subjected to 7 days soaking in water, followed by patting with a dry cloth to remove excess water, and then tested (before any drying or conditioning) while still damp. In the data presented below, the water resistance tensile retention rate and the water resistance elongation are reported as a % retention (e.g., if the initial specimen test score was 100 units and the test records a value of 80 units for the specimen tested after the 7 day soak, then the % retention is 80% retention).

The testing machine is of the constant-rate-of-crosshead-movement type, and comprises essentially (i) a fixed member (a fixed or essentially stationary member carrying one grip), (ii) a moveable member (a moveable member carrying a second grip), and (iii) grips (grips for holding the test specimen between the fixed member and the moveable member of the testing machine. The test specimen is inserted and clamped in the grips to ensure that the test specimen is aligned so that the long axis of the test specimen coincides with the direction of pull through the center line of the grip assembly. An extensometer with an initial gage length of 50 mm was used for all testing.

The test specimens were prepared in the ASTM standard D412-15A dumbbell shape specified in Die C, having a thickness of 0.25 to 3 mm and a length of 96 to 120 mm. The test specimens were prepared by first mixing together the desired components of the waterborne cementitious coating. The mixed composition was then then applied in 2 layers to a nonstick polypropylene substrate using a doctor blade to achieve a dried thickness of 0.25 to 3 mm with a 24 hour cure between each layer. The final coating was allowed to cure for 4 or 4-7 days at 23° C. temperature and 50% relative humidity. Once cured, the coating layer was removed from the non-stick substrate, and subsequently allowed to further cure for 48 hours at 40° C. and 50% relative humidity. Next, the samples were cooled to 23° C.±2° C. for at least one hour. The samples were then cut into ASTM standard D412-15A, Die C, dumbbell shape test specimens. Another set of test specimens was soaked for 7 days in water after the initial dry time and tested for wet tensile strength while the specimens were still wet.

The test specimen is elongated in the testing machine until rupture of the test specimen occurs; the testing machine is computerized and determines the specimen elongation (by measuring the increase in length using the extensometer from the point of original load application to the point of rupture), and measures the tensile pull in kg required to rupture the specimen.

Elongation % is calculated using the equation: (ΔL/L)×100%; where: ΔL=increase in specimen length to break, and L=initial specimen length (gage length).

Tensile Strength, (units of kg/m²) is calculated using the equation=(Pᵣ)/(TW); where: Pᵣ=tensile pull to rupture in kg; T=thickness of test specimen in m; W=width of test specimen in m. Here, Tensile Strength is reported in MPa. 1 MPa=101,972 kg/m².

Tensile properties may vary with specimen thickness, method of preparation, gage length, rate of load application, tensile tester response, and type of grips used. Accordingly, these factors are held constant across the data sets presented below in order to allow comparison of the data.

Employed herein as a comparative example is formulation HWR104, which corresponds to the below liquid and powder components. The styrene-butadiene polymer latex of HWR104 is Tylac 4193 (Mallard Creek, USA) which comprises 50.5-52.5 wt % solids, has Tg of −15°° C., and is an aqueous emulsion. A typical HWR-104 formulation for a 70% polymer solution (1:1.43 liquid to polymer ratio) is:

| Ingredient | Grams |
|---|---|
| Liquid Ingredients Mixture: | |
| SB latex Tylac 4193 | 564.7 |
| Water | 64.9 |
| Buffer | 1.7 |
| Defoamer | 2.3 |
| Pigment wetting/dispersing agent | 1.7 |
| Epoxysilane crosslinker | 2.8 |
| HEUR Thickener | 0.9 |
| Powder Ingredients Mixture: | |
| White Portland cement | 269.4 |
| Calcium Carbonate | 427.6 |
| Silica | 180.0 |
| Strengthening agent | 13.5 |
| Superplasticizer | 1.8 |

In China, there are currently three levels of performance standards for waterborne cementitious coatings designed for water resistance in frequently wet conditions. No product on the market meets the highest level of performance standard, GB/50108, the performance criteria for which are detailed in Table 1, below.

TABLE 1
Performance criteria for the GB/50108 performance standard.

| | GB/50108 |
|---|---|
| Initial Tensile Strength (MPa) | ≥1.8 |
| Initial Elongation (%) | ≥80 |
| Water Resistance Tensile Strength Retention Rate (%) | ≥80 |
| Water Resistance Elongation Retention Rate (%) | ≥80 |

Retention of mechanical properties after long term soaking is necessary to perform well in frequently wet applications such as below grade water proofing and civil transportation tunnels. Retention of tensile strength after long term soaking is a more challenging target attribute than retention of elongation because, upon wetting, emulsion polymers and flexible cement films made therefrom tend to naturally reduce tensile strength and increase elongation through hydroplasticization.

### Example 1: Effect of Polymer Composition and Additives

In this example, a variety of polymer latex components were compared as follows. The polymers were formulated into flexible cement membranes and tested for tensile strength and elongation initially and after a seven day water soak (Table 2, below). The standard formulation was a cementitious coating formulated with a 40:20:40 ratio (by weight including water) of liquid polymer emulsion:cement:filler (for example, 40 g liquid polymer emulsion; 20 g cement; 40 g filler thereby providing a 100 g sample, wherein the cement was Portland cement and the filler was silica).

Each formulation is formulated as 80% L:P, which includes all liquid components in Liquid and all solid components in Powder: (72 g liquid/90 gram powder=1:1.25 ratio of liquid/powder) and 2K cement, and includes crosslinker (XL) Coatosil® MP-200 (2% solids on polymer solids unless otherwise noted), Triton X-100 surfactant, (6% solids on polymer solids) and buffer (Buffer=Diammonium phosphate 0.59% on polymer solids) added. Here, the emulsion polymer composition was varied. The cement used is a two-pack coating (2K cement)

The results are shown in Table 2.

TABLE 2
Effect of polymer latex composition on tensile and elongation parameters.

| | | | | | | | | | | | | | TS | | Dry | Wet | |
|---|---|---|---|---|---|---|---|---|---|---|---|---|---|---|---|---|---|
| | BA | EHA | MMA | Styrene | MAA | IA | nDDM | Tg | PS | % | Dry | Wet | % | H2O | Elong | Elong | Elong % |
| Sample ID | (%) | (%) | (%) | (%) | (%) | (%) | (%) | (° C.) | (nm) | XL | TS | TS | ret. | Abs | (%) | (%) | ret. |
| 3.117B | | 65.0 | | 34.0 | 1.0 | | | −12.7 | 360 | 0 | 1.2 | 0.7 | 58 | 8.3 | 273 | 277 | 101 |
| 3.117B | | 65.0 | | 34.0 | 1.0 | | | −12.7 | 360 | 2 | 1.5 | 1.2 | 80 | 8.2 | 223 | 177 | 79 |
| 3.120A | | 63.5 | | 34.0 | 2.5 | | | −11.7 | 390 | 0 | 3.1 | 1.2 | 39 | 7.6 | 59 | 39 | 66 |
| 3.120A | | 63.5 | | 34.0 | 2.5 | | | −11.7 | 390 | 2 | 3.8 | 2.2 | 58 | 7.8 | 43 | 46 | 107 |
| 3.121B | 73.0 | | | 24.5 | 2.5 | | 0.2 | −16.3 | 268 | 0 | 2.3 | 0.9 | 39 | 7.5 | 97 | 112 | 115 |
| 3.121B | 73.0 | | | 24.5 | 2.5 | | 0.2 | −16.2 | 268 | 2 | 3.4 | 1.8 | 53 | 8.5 | 69 | 81 | 117 |
| 3.122A | | 64.0 | 33.5 | | | 2.5 | | −17.6 | 284 | 0 | 2.1 | 1.4 | 67 | 5.6 | 77 | 29 | 38 |
| 3.122A | | 64.0 | 33.5 | | | 2.5 | | −17.6 | 284 | 2 | 2.7 | 1.7 | 63 | 6.4 | 77 | 35 | 45 |
| 3.123B | | 65.5 | 33.5 | | | 1.0 | | −19.8 | 284 | 0 | 1.1 | 0.7 | 64 | 9.0 | 128 | 84 | 66 |
| 3.123B | | 65.5 | 33.5 | | | 1.0 | | −19.8 | 284 | 2 | 1.5 | 1.3 | 87 | 6.5 | 145 | 74 | 51 |
| 3.124A | | 64.0 | 35.0 | | 1.0 | | | −19.9 | 279 | 0 | 1.6 | 1.1 | 69 | 8.3 | 113 | 76 | 67 |
| 3.124A | | 64.0 | 35.0 | | 1.0 | | | −19.9 | 279 | 2 | 2.6 | 2.0 | 77 | 6.4 | 130 | 75 | 58 |
| 3.125B | | 64.0 | 34.3 | | 1.7 | | | −20.1 | 276 | 0 | 2.5 | 1.3 | 52 | 3.9 | 123 | 45 | 37 |
| 3.125B | | 64.0 | 34.3 | | 1.7 | | | −20.1 | 276 | 2 | 3.8 | 2.8 | 74 | 6.4 | 77 | 66 | 86 |
| 3.126A | | 64.0 | 34.3 | | | 1.7 | | pend | 277 | 0 | 1.7 | 1.1 | 65 | 7.1 | 95 | 47 | 49 |
| 3.126A | | 64.0 | 34.3 | | | 1.7 | | pend | 277 | 2 | 2.2 | 1.6 | 73 | 6.4 | 84 | 47 | 56 |
| HWR104 | | | | | | | | | | 1 | 2.2 | 1.8 | | 4.0 | 114 | 147 | 129 |

In the above table, the following acronyms are used to represent the respective monomers, chemical agents, and parameters: BA=butyl acrylate; MMA=methyl methacrylate; EHA=2-ethyl-hexyl acrylate; IA=itaconic acid nDDM=dodecylmercaptan chain transfer agent; XL=cross-linking agent CoatOSil® MP-200; PS=particle size; TS=tensile strength (MPa); ret.=retained; Elong.=elongation; H2O Abs=water absorbed.

Comparing 0 vs 2% crosslinker, the crosslinker improves initial dry tensile strength vs. no crosslinker. The use of crosslinker also improves wet tensile strength and with it retained tensile strength. This is more apparent in hydrophobic compositions which contain EHA, styrene or both. Improvements are also observed with IA (itaconic acid) and MP-200 though improvements are not as good as polymer latexes comprising MAA (methacrylic acid).

Lower acid levels (i.e. 1.7 and 1.0) appear to work better than higher acid (i.e. 2.5). Elongation is improved by the addition of 0.2% nDDM which lowers the molecular weight of the polymer.

### Example 2: Coating Recipe at 70% L:P

A second set of samples having a L:P ratio of 70% in a two pack cement coating was tested. The results are shown in Table 3.

TABLE 3
All 70% L/P Polymer, 2K cement

| | | | | | | | | | | | | | Dry | Wet | |
|---|---|---|---|---|---|---|---|---|---|---|---|---|---|---|---|
| | BA | EHA | Styrene | MAA | nDDM | Tg | PS | % | Dry | Wet | TS % | H2O | Elong | Elong | Elong % |
| Sample ID | (%) | (%) | (%) | (%) | (%) | (° C.) | (nm) | XL | TS | TS | ret. | Abs | (%) | (%) | ret. |
| HWR104 | | | | | | | | | 2.3 | 2.2 | 96 | 4.3 | 109 | 107 | 98 |
| 3.117B | | 65.0 | 34.0 | 1.0 | | −12.7 | 360 | 0 | NA | NA | NA | 8.3 | NA | NA | |
| 3.117B | | 65.0 | 34.0 | 1.0 | | −12.7 | 360 | 2 | 1.0 | 1.2 | 120 | 8.2 | 144 | 112 | 78 |
| 3.120A | | 63.5 | 34.0 | 2.5 | | −11.7 | 390 | 0 | 2.3 | 1.1 | 48 | 7.6 | 60 | 31 | 52 |
| 3.120A | | 63.5 | 34.0 | 2.5 | | −11.7 | 390 | 2 | 3.4 | 2.4 | 71 | 7.8 | 48 | 43 | 90 |
| 3.121B | 73.0 | | 24.5 | 2.5 | 0.2 | −16.3 | 268 | 0 | 2.0 | 1.2 | 60 | 7.5 | 68 | 77 | 113 |
| 3.121B | 73.0 | | 24.5 | 2.5 | 0.2 | −16.2 | 268 | 2 | 2.8 | 1.9 | 68 | 8.5 | 94 | 84 | 89 |

The set presented in Table 3 is made using a coating recipe at 70% L:P=63 g liquid/90 gram powder=1:1.43 ratio of liquid/powder. All polymer samples in this set are EHA/styrene/methacrylic acid. Even though this formulation is lower in polymer, MP-200 also improves dry tensile strength and wet tensile strength and retained tensile strength versus no MP-200 crosslinker. In addition the use of nDDM increases the initial dry elongation, wet elongation and retained elongation

### Example 3: Effect of Crosslinker Identity

Using a polymer latex of EHA, styrene, MAA, and IA, the effect of crosslinker was tested. WL-78 refers to Wetlink 78, a monomeric epoxysilane, while mp200 refers to oligomeric cross-linking agent CoatOSil® MP-200. The results are shown in Table 4.

TABLE 4
All 70% L:P Liquid/Powder, 2K Cement: MP-200 vs. WL-78 epoxysilane

| | | | | | | | | | | | | Dry | Wet | Elong |
|---|---|---|---|---|---|---|---|---|---|---|---|---|---|---|
| Sample | EHA | Styrene | MAA | | PS | % | XL | Dry | Wet | TS % | H2O | Elong | Elong | % |
| ID | (%) | (%) | (%) | Tg ° C. | (nm) | XL | used | TS | TS | ret. | Abs | (%) | (%) | ret. |
| 3.116A | 63.5 | 34.0 | 2.5 | −10.9 | 427 | 0 | none | 2.9 | 0.9 | 31 | 8.8 | 58 | 28 | 48 |
| 3.116A | 63.5 | 34.0 | 2.5 | −10.9 | 427 | 0.5 | MP200 | 3.2 | 1.4 | 44 | 8.7 | 52 | 42 | 81 |
| 3.116A | 63.5 | 34.0 | 2.5 | −10.9 | 427 | 1 | MP200 | 3.7 | 1.8 | 49 | 7.9 | 51 | 54 | 106 |
| 3.116A | 63.5 | 34.0 | 2.5 | −10.9 | 427 | 2 | MP200 | 3.4 | 1.9 | 56 | 8.9 | 49 | 63 | 129 |
| 3.116A | 63.5 | 24.5 | 2.5 | −10.9 | 427 | 0.5 | WL-78 | 3.0 | 1.3 | 43 | 7.8 | 68 | 39 | 57 |
| 3.116A | 53.5 | 24.5 | 2.5 | −10.9 | 427 | 1 | WL-78 | 2.9 | 1.3 | 45 | 8.9 | 62 | 39 | 63 |
| 3.116A | 63.5 | 24.5 | 2.5 | −10.9 | 427 | 2 | WL-78 | 3.0 | 1.4 | 47 | 8.6 | 69 | 46 | 67 |

This data in Table 4 uses one composition (i.e. EHA/Styrene/methacrylic acid) but compares Momentive MP-200 (oligomeric epoxysilane) to Momentive Silquest Wetlink 78 (monomeric epoxysilane) at several levels. Results here show that MP-200 improves initial tensile, wet tensile and tensile retained over WL-78. In addition MP-200 improves wet elongation and elongation retained versus WL-78.

### Example 4: Effect of Monomer and Crosslinker on Dry Tensile Strength

In a series of experiments, the effect of cross linker and monomer mixture was assayed. In each test, the L/P ratio was 70%. Each mixture also included 6% Triton-X100 surfactant. MP-200 level is 1% on polymer solids. The results are shown in Tables 5 to 10.

TABLE 5
BA/Styrene/MAA with and without crosslinker

| | | | | | | | | | | Dry | Wet |
|---|---|---|---|---|---|---|---|---|---|---|---|
| Sample | BA | Styrene | MAA | | PS | XL | Dry | Wet TS | H2O | Elong | Elong |
| ID | (%) | (%) | (%) | Tg ° C. | (nm) | used | TS | (TS ret.) | Abs | (%) | (%) |
| 2.83a | 73.0 | 25.5 | 1.5 | −15.9 | 278 | no XL | 2.4 | 1.3 (54) | 6.1 | 85 | 56 |
| 2.83a | 73.0 | 25.5 | 1.5 | −15.9 | 278 | MP200 | 3.0 | 1.6 (53) | 7.7 | 87 | 68 |
| 2.87a | 73.0 | 24.5 | 2.5 | −14.2 | 271 | no XL | 3.6 | 1.2 (33) | 7.2 | 53 | 34 |
| 2.87a | 73.0 | 24.5 | 2.5 | −14.2 | 271 | MP200 | 4.6 | 1.8 (41) | 6.7 | 59 | 41 |
| 2.84b | 73.0 | 24.5 | 2.5 | −15.2 | 278 | no XL | 3.8 | 1.4 (37) | 6.3 | 54 | 34 |
| 2.84b | 73.0 | 24.5 | 2.5 | −15.2 | 278 | MP200 | 4.4 | 1.9 (43) | 6.4 | 53 | 37 |

The data in Table 5 shows that MP-200 increases dry tensile strength, wet tensile strength, tensile strength retained, initial elongation and wet elongation.

TABLE 6
BA/MMA/MAA with and without crosslinker

| | | | | | | | | | | Dry | Wet |
|---|---|---|---|---|---|---|---|---|---|---|---|
| Sample | BA | MMA | MAA | | PS | XL | Dry | Wet TS | H2O | Elong | Elong |
| ID | (%) | (%) | (%) | Tg ° C. | (nm) | used | TS | (TS ret.) | Abs | (%) | (%) |
| 2.85a | 70.0 | 28.5 | 1.5 | −14.2 | 270 | no XL | 2.7 | 1.3 (48) | 6.0 | 57 | 26 |
| 2.85a | 70.0 | 28.5 | 1.5 | −14.2 | 270 | MP200 | 3.6 | 1.7 (47) | 7.1 | 75 | 25 |
| 2.86b | 70.0 | 27.5 | 2.5 | −13.7 | 260 | no XL | 4.2 | 1.4 (33) | 5.6 | 37 | 16 |
| 2.86b | 70.0 | 27.5 | 2.5 | −13.7 | 260 | MP200 | 4.8 | 2.1 (44) | 4.8 | 40 | 17 |
| 2.88b | 70.0 | 27.5 | 2.5 | −13.0 | 263 | no XL | 4.3 | 1.2 (28) | 5.7 | 43 | 13 |
| 2.88b | 70.0 | 27.5 | 2.5 | −13.0 | 263 | MP200 | 6.0 | 2.4 (40) | 6.3 | 40 | 18 |

The data in Table 6 show that MP-200 increases dry tensile, wet tensile and retained tensile strength.

TABLE 7
EHA/MMA/MAA with and without crosslinker

| | | | | | | | | | | Dry | Wet |
|---|---|---|---|---|---|---|---|---|---|---|---|
| Sample | EHA | MMA | MAA | | PS | XL | Dry | Wet TS | H2O | Elong | Elong |
| ID | (%) | (%) | (%) | Tg ° C. | (nm) | used | TS | (TS ret.) | Abs | (%) | (%) |
| 2.93b | 64.0 | 33.5 | 2.5 | −18.2 | 267 | no XL | 3.4 | 0.4 (12) | 9.4 | 19 | 5 |
| 2.93b | 64.0 | 33.5 | 2.5 | −18.2 | 267 | MP200 | 5.3 | 3.4 (64) | 9.1 | 25 | 15 |
| 3.124a | 64.0 | 35.0 | 1.0 | −19.9 | 276 | no XL | 2.2 | 1.6(73) | 5.7 | 63 | 13 |
| 3.124a | 64.0 | 35.0 | 1.0 | −19.9 | 276 | MP200 | 2.6 | 2.0(77) | 6.3 | 83 | 42 |
| 3.125b | 64.0 | 34.3 | 1.7 | −20.1 | 277 | no XL | 2.7 | 1.6(59) | 5.5 | 55 | 20 |
| 3.125b | 64.0 | 34.3 | 1.7 | −20.1 | 277 | MP200 | 3.7 | 2.8(76) | 6.6 | 57 | 33 |

The data in Table 7 show that MP-200 increases dry tensile strength, wet tensile strength and retained tensile strength.

TABLE 8
EHA/Styrene/MMA with and without crosslinker

| | | | | | | | | | | Dry | Wet |
|---|---|---|---|---|---|---|---|---|---|---|---|
| Sample | EHA | Styrene | MAA | | PS | XL | Dry | Wet TS | H2O | Elong | Elong |
| ID | (%) | (%) | (%) | Tg ° C. | (nm) | used | TS | (TS ret.) | Abs | (%) | (%) |
| 3.116a | 63.5 | 34.0 | 2.5 | −10.9 | 427 | no XL | 3.3 | 1.1(33) | 6.1 | 48 | 27 |
| 3.116a | 63.5 | 34.0 | 2.5 | −10.9 | 427 | MP200 | 3.2 | 1.9(59) | 7.5 | 38 | 33 |
| 3.117b | 65.0 | 34.0 | 1.0 | −12.7 | 360 | no XL | 1.2 | 0.9(75) | 6.2 | 160 | 97 |
| 3.117b | 65.0 | 34.0 | 1.0 | −12.7 | 360 | MP200 | 1.4 | 1.3(93) | 7.0 | 179 | 124 |
| 3.120a | 63.5 | 34.0 | 2.5 | −11.7 | 390 | no XL | 3.0 | 1.5(50) | 5.3 | 54 | 36 |
| 3.120a | 63.5 | 34.0 | 2.5 | −11.7 | 390 | MP200 | 3.6 | 2.6(72) | 5.7 | 54 | 37 |

The data in Table 8 show that MP-200 increases dry tensile, wet tensile and retained tensile strength.

TABLE 9
EHA/MMA/IA with and without crosslinker

| | | | | | | | | | | Dry | Wet |
|---|---|---|---|---|---|---|---|---|---|---|---|
| Sample | EHA | MMA | IA | | PS | XL | Dry | Wet TS | H2O | Elong | Elong |
| ID | (%) | (%) | (%) | Tg ° C. | (nm) | used | TS | (TS ret.) | Abs | (%) | (%) |
| 2.94a | 62.5 | 36.5 | 1 | −16.1 | 277 | no XL | 2.0 | 1.9 (95) | 5.2 | 75 | 40 |
| 2.94a | 62.5 | 36.5 | 1 | −16.1 | 277 | MP200 | 1.8 | 1.3 (72) | 6.6 | 71 | 35 |
| 3.122a | 64.0 | 33.5 | 2.5 | −17.6 | 284 | no XL | 2.7 | 1.5(56) | 6.2 | 56 | 24 |
| 3.122a | 64.0 | 33.5 | 2.5 | −17.6 | 284 | MP200 | 2.6 | 1.5(58) | 9.4 | 39 | 22 |
| 3.123b | 65.5 | 33.4 | 1.0 | −19.8 | 284 | no XL | 1.5 | 1.4(93) | 6.4 | 119 | 47 |
| 3.123b | 65.5 | 33.4 | 1.0 | −19.8 | 284 | MP200 | 1.6 | 1.4(88) | 6.7 | 95 | 55 |
| 3.126a | 64.0 | 34.3 | 1.7 | −21.2 | 277 | no XL | 2.1 | 1.3(62) | 6.9 | 61 | 37 |
| 3.126a | 64.0 | 34.3 | 1.7 | −21.2 | 277 | MP200 | 2.0 | 1.5(75) | 6.9 | 61 | 32 |

The data in Table 9 show that MP-200, at an optimum level of 1.7 IA, increases wet tensile and retained tensile strength.

TABLE 10
BA/[MMA or styrene]/MAA with nDDM, with and without crosslinker

| | | | | | | | | | | | | Dry | Wet |
|---|---|---|---|---|---|---|---|---|---|---|---|---|---|
| Sample | BA | MMA | Styrene | MAA | nDDM | | PS | XL | Dry | Wet TS | H2O | Elong | Elong |
| ID | (%) | (%) | (%) | (%) | (%) | Tg ° C. | (nm) | used | TS | (TS ret.) | Abs | (%) | (%) |
| 3.121b | 73.0 | | 24.5 | 2.5 | 0.2 | −16.3 | 268 | no XL | 2.6 | 1.0(39) | 9.4 | 96 | 92 |
| 3.121b | 73.0 | | 24.5 | 2.5 | 0.2 | −16.3 | 268 | MP200 | 2.9 | 1.5(49) | 7.8 | 81 | 76 |
| 3.106b | 73.0 | | 24.5 | 2.5 | 0.5 | −16.2 | 275 | no XL | 2.4 | 0.8(33) | 8.2 | 65 | 66 |
| 3.106b | 73.0 | | 24.5 | 2.5 | 0.5 | −16.2 | 275 | MP200 | 2.2 | 0.9(41) | 8.5 | 63 | 73 |
| 3.105a | 70.0 | 27.5 | | 2.5 | 0.5 | −17.4 | 263 | no XL | 2.8 | 0.4(14) | 14.4 | 49 | 42 |
| 3.105a | 70.0 | 27.5 | | 2.5 | 0.5 | −17.4 | 263 | MP200 | 3.0 | 0.6(20) | 12.7 | 40 | 51 |

The data in Table 10 show that MP-200 increases tensile strength retention.

When ranges are used herein for physical properties, such as temperature ranges and pH ranges, or chemical properties, such as chemical formulae, all combinations, and sub-combinations of ranges and specific embodiments therein are intended to be included.

The disclosures of each patent, patent application, and publication cited or described in this document are hereby incorporated herein by reference, in their entirety.

While the preferred forms of the invention have been disclosed, it will be apparent to those skilled in the art that various changes and modifications may be made that will achieve some of the advantages of the invention without departing from the spirit and scope of the invention. It is, therefore, intended that the appended claims cover all such equivalent variations as fall within the true spirit and scope of the invention.

We claim:

1. A waterborne cementitious coating composition comprising:
a) an aqueous polymer latex comprising:
a first monomer selected from the group consisting of a vinylarene monomer and a (meth)acrylate monomer;
a second monomer which is a meth(acrylate) monomer; and
one or more epoxy silane; and
b) an inorganic component comprising:
cement; and
one or more solid filler.

2. The composition of claim 1, wherein the first monomer comprises a vinylarene monomer.

3. The composition of claim 1, wherein the first monomer comprises a (meth)acrylate monomer and wherein the first monomer is different from the second monomer.

4. The composition of claim 1, wherein the aqueous polymer latex comprises 50-90% first monomer and 10-50% second monomer by weight of dried polymer.

5. The composition of claim 1, wherein the first monomer comprises a vinylarene monomer selected from the group consisting of styrene, 4-methoxystyrene, 3-methoxystyrene, 2-methoxystyrene, 4-tert-butoxystyrene, 4-acetoxystyrene, 4-tert-butylstyrene, 4-vinylbiphenyl, 4-vinylbenzoic acid, 3,4-dimethoxystyrene, 2-vinylnaphthalene, 4-methylstyrene, 2-methylstyrene, 2,4-dimethylstyrene, 2,4,6-trimethylstyrene, 1,1-diphentylethylene, 4-chlorostyrene, a-methyl analogs thereof, and combinations thereof.

6. The composition of claim 1, wherein the first monomer and the second monomer independently comprise a monomer selected from the group consisting of methyl (meth)acrylate, ethyl (meth)acrylate, propyl (meth)acrylate, isopropyl (meth)acrylate, the n-butyl (meth)acrylate, sec-butyl (meth)acrylate, iso-butyl (meth)acrylate, tert-butyl (meth)acrylate, amyl (meth)acrylate, hexyl (meth)acrylates, cyclohexyl(meth)acrylates, 2-ethylhexyl and other octyl (meth)acrylates, nonyl (meth)acrylates, decyl (meth)acrylates, lauryl (meth)acrylate, stearyl (meth)acrylate, (meth)acrylic acid, (meth)acrylamide, hydroxyethyl (meth)acrylate, glycidal (meth)acrylate, itaconic acid, and combinations, co-polymers, and block-copolymers thereof.

7. The composition of claim 1, wherein the aqueous polymer latex further comprises 0.1% to 10% of a third monomer selected from the group consisting of (meth)acrylic acid, itaconic acid, 3-(acryloyloxy)propionic acid, acetoacetoxy ethyl (meth)acrylate (AAEM), diacetone (meth)acrylamide (DAAM), (hydroxyethyl) (meth)acrylate (HEMA), and glycidyl (meth)acrylate (GMA).

8. The composition of claim 1, wherein the one or more epoxy silane comprises an oligomeric epoxy silane.

9. The composition of claim 1, wherein the one or more epoxy silane comprises: 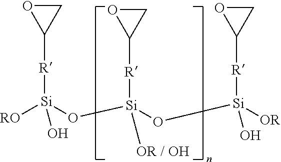
wherein R′ is —(CH₂)ₓ—O—(CH₂)_{y}—; x and y are independently from 0 to 5; R is selected from a C1 to C6 alkyl group, an aromatic group and mixtures thereof, and n is from 0 to 8, limits inclusive.

10. The composition of claim 1, wherein the cement comprises Portland Cement or calcium aluminate cement.

11. The composition of claim 1, wherein the composition has a polymer latex to inorganic component ratio, based on solids, of from 5:1 to 1:5.

12. The composition of claim 1, wherein the filler comprises calcium carbonate, silica, fumed silica, metakaolin, or a combination thereof.

13. The composition of claim 1, wherein the composition further comprises a buffer, a superplasticizer, or a chain transfer agent.

14. A method for forming a water-resistant, flexible cementitious coating, layer or membrane comprising:
applying the waterborne cementitious coating composition of claim 1 to a substrate to form a wet cementitious coating layer; and
drying or curing the wet cementitious coating layer to form a dried and/or cured cementitious coating, layer or membrane.

15. The method of claim 14, wherein the substrate comprises concrete, stone, bricks, tile, cementitious materials, metal, wood, or synthetic materials.

16. The method of claim 14, further comprising the step of adjusting the pH of the polymer latex to a pH of 5 to 9 before or after mixing the one or more epoxy silane with polymer latex.

17. A kit comprising:
an aqueous polymer latex;
one or more epoxy silane;
cement; and
one or more solid filler;
wherein the aqueous polymer latex comprises a first monomer selected from the group consisting of a vinylarene monomer and a (meth)acrylate monomer; and a second monomer which is a meth(acrylate) monomer; and
wherein the one or more epoxy silane comprises one or more one epoxy functional group and one or more hydrolysable siloxy, silane, or silanol functional groups.

18. The kit of claim 17, wherein the aqueous polymer latex and the one or more epoxy silane are contained in a first pack and wherein the cement and one or more solid filler are contained in a second pack.

19. A water-resistant, flexible cementitious coating, layer or membrane comprising:
a polymer latex comprising:
a first monomer selected from the group consisting of a vinylarene monomer and a (meth)acrylate monomer; and
a second monomer which is a meth(acrylate) monomer;
cement;
one or more solid filler; and
an epoxy silane or epoxy silane residue.

20. The water-resistant, flexible cementitious coating, layer or membrane of claim 19, further comprising at least one additive selected from the group consisting of a buffer, and a superplasticizer.
